(19) United States
(12) Patent Application Publication
(10) Pub. No.: US 2021/0408868 A1
(43) Pub. Date: Dec. 30, 2021

(54) MOTOR ASSEMBLY AND CLEANER INCLUDING THE SAME

(71) Applicant: SAMSUNG ELECTRONICS CO., LTD, Suwon-si, Gyeonggi-do (KR)

(72) Inventor: Tae Sang PARK, Suwon-si (KR)

(73) Assignee: SAMSUNG ELECTRONICS CO., LTD, Suwon-si, Gyeonggi-do (KR)

(21) Appl. No.: 16/645,177

(22) PCT Filed: Aug. 30, 2018
(86) PCT No.: PCT/KR2018/010059

§ 371 Date: Mar. 6, 2020

(30) Foreign Application Priority Data
Sep. 6, 2017 (KR) 10-2017-0113648

(51) Int. Cl. H02K 7/00; H02K 7/14; A47L 5/24; A47L 5/36; A47L 9/22

(52) U.S. Cl. CPC H02K 7/003; H02K 7/14; H02K 9/02; A47L 5/362; A47L 9/22; A47L 5/24

(57) ABSTRACT

The present disclosure relates to a motor assembly improving a coupling structure of a rotor shaft and an impeller, and a cleaner including the same. The motor assembly includes a stator, a rotor including a rotor shaft including a metallic material and configured to be rotatable by electromagnetic interaction with the stator, a hub including a plastic material and including a hollow portion configured to allow the rotor shaft to pass therethrough, and a shaft coupling member positioned between the hollow portion and the rotor shaft and including a plastic material different from a plastic material forming the hub.

### TECHNICAL FIELD

The present disclosure relates to a motor assembly improving a coupling structure of a rotor shaft and an impeller, and a cleaner including the same.

### BACKGROUND ART

In general, a motor, which is a device providing a rotational force using electrical energy, includes a stator and a rotor. The rotor is configured to electromagnetically interact with the stator and rotated by a force acting between a magnetic field and an electric current flowing through a coil.

The motor may be used in various home appliances, for example, a cleaner or the like.

A cleaner is a home appliance that sucks air containing foreign substances such as dust by using air pressure generated by a motor mounted inside a cleaner body and then filters out the foreign substances in the inside of the cleaner body.

The motor generates a suction force by lowering an internal pressure by discharging air inside the cleaner to the outside. Suction devices sucks foreign substances such as dust on a surface to be cleaned together with the outside air using the suction force generated by the motor and a dust collector removes the foreign substances.

The motor rotates the rotor to generate a suction force by an impeller rotating with the rotor, and these components may be arranged in one module. That is, the impeller may be a component that determines the suction force of the cleaner.

The impeller is a part that generates a suction force by the rotational movement, and metal or plastic material is mainly used. The plastic material is lightweight and has good formability but is not suitable for the impeller that rotates at a high speed because the plastic material has a lower strength than the metallic material.

Recently, in order to compensate for the above weak point, high-strength plastics with reinforced strength have been developed. Examples of high strength plastics include reinforced PolyEther Ether Ketone (PEEK) containing carbon fiber, reinforced PolyPhenylene Sulfide (PPS), reinforced PolyPhthalAmide (PPA), and reinforced PolyAmide (PA).

Although the high-strength plastic has a tensile strength of approximately 200 MPa or more, due to its low elongation at break, the high-strength plastic may fail to withstand plastic deformation when a rotor shaft is press-fitted into the impeller and may be damaged, so that the high-strength plastic may not be applied to the impeller.

Because the impeller formed of a high-strength plastic material has a low static friction coefficient with the rotor shaft formed of a metallic material, when the impeller is rotating at a high speed, slippage may occur between the rotor shaft and the impeller.

### DISCLOSURE

### Technical Problem

The present disclosure is directed to providing a motor assembly including a high speed rotating impeller, and a cleaner including the same.

The present disclosure is directed to providing a motor assembly including a low vibration and low noise impeller, and a cleaner including the same.

The present disclosure is directed to providing a motor assembly having the improved manufacturing efficiency of the motor assembly by improving the coupling structure between an impeller and a rotor shaft to strengthen the coupling of the impeller and the rotor shaft, and a cleaner including the same.

### Technical Solution

One aspect of the present disclosure provides a motor assembly including a stator, a rotor including a rotor shaft constituted of a metallic material and rotatably configured by electromagnetic interaction with the stator, a hub constituted of a plastic material and including a hollow portion configured to allow the rotor shaft to pass therethrough, and a shaft coupling member positioned between the hollow portion and the rotor shaft and constituted of a plastic material different from the hub.

The plastic material constituting the shaft coupling member may have a higher elongation at break than the plastic material constituting the hub.

The plastic material constituting the shaft coupling member may have a higher static friction coefficient with the metallic material than the plastic material constituting the hub.

The plastic material constituting the shaft coupling member may include a soft material having a lower tensile strength than the plastic material constituting the hub.

The shaft coupling member may include a body portion accommodated in the hollow portion and a head portion extending in a radial direction of the rotor shaft from an upper side of the body portion.

A diameter of the head portion may be larger than a diameter of the hollow portion to prevent the hub from being separated from the rotor shaft.

The shaft coupling member may include a shaft insertion hole to allow the rotor shaft to be inserted, and a diameter of the shaft insertion hole may be smaller than a diameter of the rotor shaft such that the rotor shaft is press-fitted into the shaft insertion hole.

The shaft coupling member may include a shaft coupling surface in contact with the rotor shaft press-fitted into the shaft insertion hole, and the shaft coupling surface may be constituted of a plastic material different from the hub.

The shaft coupling member may be coupled to the hollow portion in a forced fitting manner.

The shaft coupling member may be insert injection molded integrally with the hollow portion.

The shaft coupling member may be double injection molded with the hollow portion.

The shaft coupling member may further include a first coupling portion provided in the body portion to prevent revolving of the body portion inserted into the hollow portion.

The hollow portion may include a second coupling portion configured to be coupled to the first coupling portion in a locking manner.

The first coupling portion may include a protrusion protruding in the radial direction of the rotor shaft from the body portion, and the second coupling portion may include a groove to allow the first coupling portion to be inserted into the second coupling portion.

Another aspect of the present disclosure provides a cleaner including a cleaner body, a suction head configured to suck foreign substances on a surface to be cleaned into the cleaner body, and a motor assembly disposed inside the cleaner body, wherein the motor assembly includes a motor comprising a rotor shaft and rotatably configured, and an impeller coupled to the rotor shaft to be rotatable together with the motor, and wherein the impeller includes a hub constituted of a high strength plastic material to prevent damage due to high speed rotation of the impeller, and a shaft coupling member coupled to a hollow portion formed in the hub and constituted of a plastic material different from the hub.

### Advantageous Effects

A motor assembly according to the present disclosure and a cleaner including the same can strengthen coupling of an impeller and a rotor shaft that generate an airflow, so that the life span thereof can be extended and the impeller and the rotor shaft can be coupled in a state of maintaining concentricity.

The motor assembly according to the present disclosure and the cleaner including the same can improve the coupling structure between the impeller and the rotor shaft, so that the coupling of the impeller and the rotor shaft can be strengthened and the manufacturing efficiency of the motor assembly can be improved.

### DESCRIPTION OF DRAWINGS

FIG. 1 illustrates a stick type cleaner including a motor assembly according to the present disclosure.

FIG. 2 is a perspective view of the motor assembly according to the present disclosure.

FIG. 3 is a cross-sectional view of the motor assembly according to the present disclosure.

FIG. 4 is an exploded perspective view of the motor assembly according to the present disclosure.

FIG. 5 is an exploded perspective view of a motor module in the motor assembly according to the present disclosure.

FIG. 6 is a perspective view illustrating a state in which an impeller and a rotor shaft are coupled in the motor assembly according to the present disclosure.

FIG. 7 is a cross-sectional view illustrating a state in which the impeller and the rotor shaft are coupled in the motor assembly according to the present disclosure.

FIG. 8 is a perspective view illustrating a state in which the impeller and the rotor shaft are separated in the motor assembly according to the present disclosure.

FIG. 9 is a cross-sectional view of the impeller excluding a shaft coupling member, which is viewed from the top to the bottom, in the motor assembly according to the present disclosure.

FIG. 10 is a cross-sectional view of the shaft coupling member, which is viewed from the bottom to the top, in the motor assembly according to the present disclosure.

FIG. 11 illustrates a canister type cleaner including the motor assembly according to the present disclosure.

### MODE OF THE INVENTION

The embodiments described in the present specification and the configurations shown in the drawings are only examples of preferred embodiments of the present disclosure, and various modifications may be made at the time of filing of the present disclosure to replace the embodiments and drawings of the present specification.

Like reference numbers or signs in the various drawings of the application represent parts or components that perform substantially the same functions.

The terms used herein are for the purpose of describing the embodiments and are not intended to restrict and/or to limit the present disclosure. For example, the singular expressions herein may include plural expressions, unless the context clearly dictates otherwise.

The terms “comprises” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms first, second, etc. may be used herein to describe various components, these components should not be limited by these terms. These terms are only used to distinguish one component from another.

For example, without departing from the scope of the present disclosure, the first component may be referred to as a second component, and similarly, the second component may also be referred to as a first component.

The term “and/or” includes any combination of a plurality of related items or any one of a plurality of related items.

Hereinafter, embodiments of the present disclosure will be described in detail with reference to the accompanying drawings.

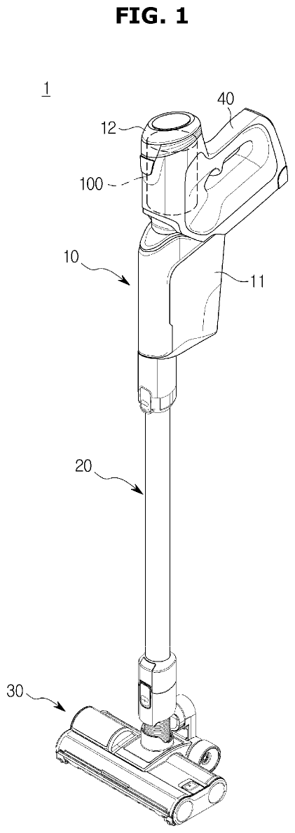

FIG. 1 illustrates a stick type cleaner including a motor assembly according to the present disclosure.

As illustrated in FIG. 1, a cleaner including a motor assembly 100 according to the present disclosure may include a stick type cleaner 1. However, the present disclosure is not limited thereto. For example, the motor assembly 100 according to the present disclosure may be used in an upright type cleaner.

The motor assembly 100 may be applied to various home appliances in addition to the cleaner. Hereinafter, the stick type cleaner 1 including the motor assembly 100 will be described.

The cleaner 1 may include a cleaner body 10 and a suction head 30. The cleaner 1 may include a stick 20 connecting the cleaner body 10 and the suction head 30 and a handle 40 connected to the cleaner body 10.

The handle 40 is a part coupled to the cleaner body 10 and may be gripped by the user so that a user may manipulate the cleaner 1. The handle 40 may be provided with a controller (not shown) such that the user may control the cleaner 1.

The suction head 30 may be disposed at a lower portion of the cleaner body 10 to be in contact with a surface to be cleaned. The suction head 30 may be in contact with the surface to be cleaned and introduce dust or dirt on the surface to be cleaned into the cleaner body 10 with a suction force generated by the motor assembly 100.

The cleaner body 10 may include a dust collector 11 and a driving device 12 provided therein. The dust collector 11 may be configured to collect dust or dirt on the surface to be cleaned sucked from the suction head 30.

The driving device 12 may include the motor assembly 100 configured to drive the cleaner 1. The motor assembly 100 may generate power such that a suction force is generated in the cleaner body 10.

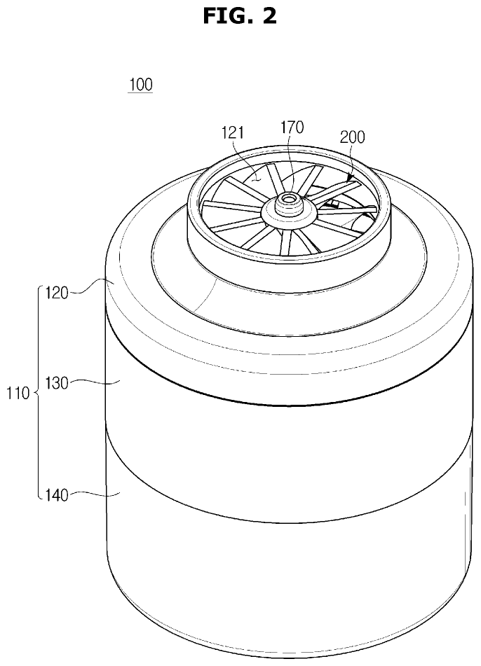

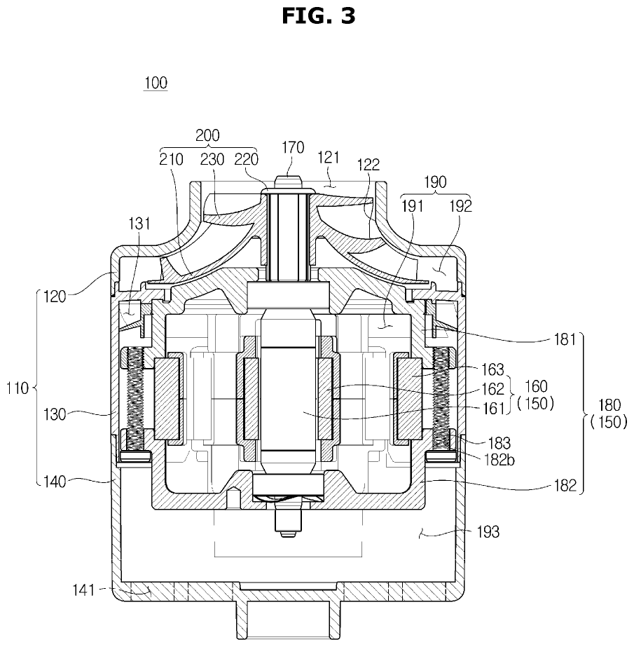

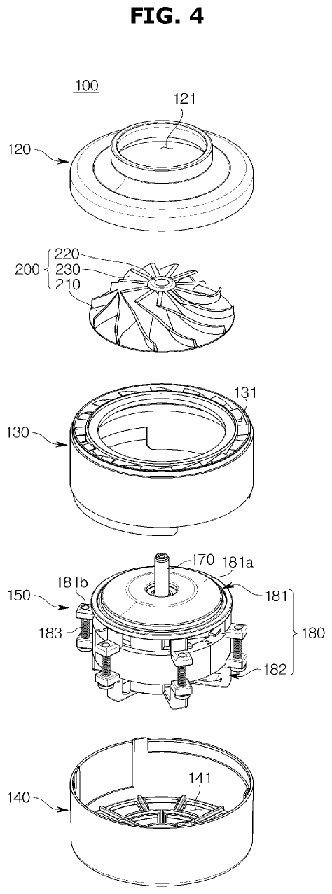

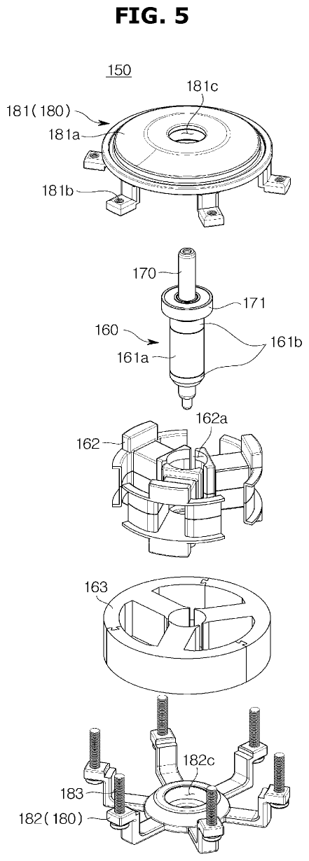

FIG. 2 is a perspective view of the motor assembly according to the present disclosure. FIG. 3 is a cross-sectional view of the motor assembly according to the present disclosure. FIG. 4 is an exploded perspective view of the motor assembly according to the present disclosure. FIG. 5 is an exploded perspective view of a motor module in the motor assembly according to the present disclosure.

As illustrated in FIGS. 2 to 5, the motor assembly 100 may include a motor module 150 including a housing 110 and a motor 160 installed inside the housing 110 to generate a suction force.

The motor module 150 may include a motor housing 180 configured to seat the motor 160. The motor housing 180 may be configured to fix the motor 160 inside the housing 110.

The motor 160 may include a rotor 161 and a stator 162. The motor 160 may include a rotor shaft 170. The motor assembly 100 may include an impeller 200 installed on the rotor shaft 170 to rotate.

The housing 110 may include a first housing 120 and a second housing 130 configured to be coupled to the first housing 120. The housing 110 may include a third housing 140 configured to be coupled to the second housing 130.

The housing 110 may be formed in a substantially cylindrical shape, but is not limited thereto and may include various shapes. The first housing 120 and the second housing 130 may be provided detachably in an axial direction of the rotor shaft 170, and the second housing 130 and the third housing 140 may be detachably provided in the axial direction of the rotor shaft 170.

The first housing 120 may include an inlet 121 configured to allow air introduced by the motor 160 to be introduced into the housing 110, and the third housing 140 may include an outlet 141 configured to allow air introduced into the housing 110 through the inlet 121 to be discharged.

By combining the first housing 120, the second housing 130, and the third housing 140, an air passage 190 leading from the inlet 121 to the outlet 141 may be formed, and an inner space 193 in which the motor 160, the impeller 200, and the like may be disposed may be formed therein.

By the impeller 200 of the motor assembly 100, air may be sucked in and the sucked air may flow through the air passage 190. The first housing 120 may surround an outer circumferential surface of the impeller 200 and may form the air passage 190.

The second housing 130 may form the air passage 190 on downstream of the impeller 200. The third housing 140 may surround an outer circumferential surface of the motor module 150 and may form the air passage 190. The air passage 190 may include a first passage 191 and a second passage 192.

The air introduced into the housing 110 may flow through the first passage 191 introduced into the motor module 150 and the second passage 192 passing between the outside of the motor module 150 and an inner side of the housing 110.

Intake air passing through the first passage 191 may cool heat generated from the inside of the motor module 150.

The first housing 120 may include a shroud 122. The shroud 122 may be configured to correspond to the impeller 200 or a diffuser 131, which will be described later, to guide air introduced into the housing 110 by the motor 160.

In order to widen the flow passage along the traveling direction of air sucked from the inlet 121 by the motor 160, the shroud 122 may be provided such that a space forming the shroud 122 with respect to the axial direction of the rotor shaft 170 is widened.

The shroud 122 may guide air introduced through the inlet 121 to the inside of the housing 110 and may be provided in a shape corresponding to an upper portion of the impeller 200.

The impeller 200 may be positioned inside the inlet 121 of the first housing 120. The impeller 200 may be configured to rotate together with the rotor shaft 170. The impeller 200 may be provided with a plurality of wings 230 to generate a flow of air.

The impeller 200 is configured such that a rotation radius of the plurality of wings 230 of the impeller 200 decreases along a direction away from the rotor 161, so that as the impeller 200 rotates, air flowing in the direction of the rotor shaft 170 may be discharged in a radial direction of the rotor shaft 170.

Although one embodiment of the impeller 200 has been described above, the shape and arrangement of the impeller 200 is not limited thereto, and a configuration capable of flowing air is sufficient. The material of the impeller 200 may include plastic.

The second housing 130 may include the diffuser 131. The diffuser 131 may be configured to increase the pressure of air flowing by the impeller 200. The diffuser 131 may be disposed a circumference along a radial direction of the impeller 200.

The diffuser 131 may be provided in the radial direction with respect to the impeller 200. The diffuser 131 may be formed in a direction extending with respect to the plurality of wings 230 of the impeller 200.

The diffuser 131 may be constituted of a plurality of ribs, and the plurality of ribs may be formed such that a distance between the plurality of ribs increases along a direction extending with respect to the plurality of wings 230.

The diffuser 131 composed of the plurality of ribs may be formed to increase the pressure of air while guiding the air flowing by the impeller 200.

The diffuser 131 and the shroud 122 formed on the first housing 120 may be formed to generate a suction force while guiding air flowing by the impeller 200.

The diffuser 131 may be provided on the same plane as a downstream end of the air flow by the impeller 200 and may be formed to have a predetermined inclination in the direction of the rotor shaft 170 such that air flows in the up-down direction, which is the direction of the rotor shaft 170, inside the housing 110.

The motor module 150 may be provided inside the housing 110. The motor module 150 may be configured such that the motor 160 is fixed inside the housing 110 as one module.

The motor module 150 may include the motor 160 and the motor housing 180. The motor housing 180 may include a second motor housing 182 configured to be coupled to a first motor housing 181 with the first motor housing 181 and the motor 160 therebetween.

The first motor housing 181 may be configured to be fixed to the housing 110. A coupling portion (not shown) may be formed in the second housing 130 to allow the motor housing 180 to be coupled thereto, and the first motor housing 181 may be coupled to the coupling portion (not shown).

The method in which the first motor housing 181 is coupled to the coupling portion (not shown) may include a fitting coupling method, but is not limited thereto.

The first motor housing 181 may include an impeller seating portion 181a. The impeller seating portion 181a may be configured to correspond to the shape of a rear surface of the impeller 200 so as not to interfere with the rotation of the impeller 200 coupled to the rotor shaft 170.

The first motor housing 181 and the second motor housing 182 each have fastening holes 181b and 182b for coupling and may be coupled by fastening members 183.

In the present embodiment, one of the fastening members 183 is disposed in each of six of the fastening holes 181b and 182b to couple and fix the first motor housing 181 and the second motor housing 182 to each other. However, the present disclosure is not limited thereto, and the shape and number of the fastening holes 181b and 182b and the fastening members 183 may be provided in various ways.

Shaft holes 181c and 182c each may be provided at the centers of the first motor housing 181 and the second motor housing 182 such that the rotor shaft 170 may pass therethrough.

Bearings 171 each may be disposed in the shaft holes 181c and 182c to allow the rotor shaft 170 to rotate. A body of the first motor housing 181 may be formed in a substantially circular shape. A body of the second motor housing 182 may be formed to correspond to the shape of the stator 162.

A rotor accommodating portion 162a for accommodating the rotor 161 may be formed at a central portion of the stator 162. The stator 162 may be formed by stacking press-processed iron plates.

The motor 160 may include an insulator 163. The insulator 163 may be constituted of a material having electrical insulation.

The insulator 163 may be formed to surround a portion of the stator 162. A coil (not shown) may be wound over the stator 162 in a state where the insulator 163 coupled to the stator 162.

Hereinafter, a process of assembling the motor assembly 100 according to the present disclosure will be described.

The stator 162 may be at least partially covered by the insulator 163 for electrical insulation. The rotor 161 may be inserted into the rotor accommodating portion 162a formed in the stator 162 coupled to the insulator 163, and the motor housing 180 may fix this configuration as one module.

When the motor 160 is seated in and coupled to the motor housing 180, the rotor shaft 170 may pass through the shaft holes 181c and 182c of the motor housing 180 such that the concentricity of the rotor 161 and the stator 162 coincide.

The motor module 150 may be coupled to the second housing 130. The first motor housing 181 may be coupled to the second housing 130.

The impeller 200 may be coupled to the rotor shaft 170. The impeller 200 may be disposed on the impeller seating portion 181a of the first motor housing 181.

The shroud 122 may be provided on an inner side surface of the first housing 120, and the shroud 122 may form the air passage 190 introduced into the housing 110 together with the impeller 200.

The rotor 161 may be disposed in the rotor accommodating portion 162a of the stator 162. The rotor 161 may be configured to electromagnetically interact with the stator 162 in the rotor accommodating portion 162a.

The rotor 161 may include the rotor shaft 170 and a magnet 161a. The rotor shaft 170 may be configured to be rotatable about an axis. One end of the rotor shaft 170 may be coupled to the impeller 200 to rotate together with the rotor 161.

The rotor shaft 170 may be provided in a rod shape. The magnet 161a may be configured to allow the rotor shaft 170 to pass therethrough. The magnet 161a may be disposed along a circumference of the rotor shaft 170.

Although the shape and arrangement of the magnet 161a are not limited, in the embodiment of the present disclosure, the magnet 161a may be provided in an annular shape, and the rotor shaft 170 may pass through the center of the annular shape.

The rotor 161 may include a support member 161b. The support member 161b may be provided adjacent to the magnet 161a. The support member 161b may be disposed adjacent to the magnet 161a in an axial direction.

A pair of the support members 161b may be provided and disposed on one side and the other side in the axial direction of the magnet 161a. The support member 161b may include a balancer.

The pair of support members 161b each may be provided on one side and the other side of the magnet 161a to compensate for eccentricity caused by the rotation of the rotor 161.

The support member 161b may be configured to allow the rotor shaft 170 to pass therethrough. The support member 161b may be disposed along the circumference of the rotor shaft 170.

Although the shape and arrangement of the support member 161b are not limited, in the embodiment of the present disclosure, the support member 161b may be provided in an annular shape, and the rotor shaft 170 may pass through the center of the annular shape.

The impeller 200 may include a hub 210 and a shaft coupling member 220 in contact with the hub 210. Hereinafter, the structure of the impeller 200 will be described in detail.

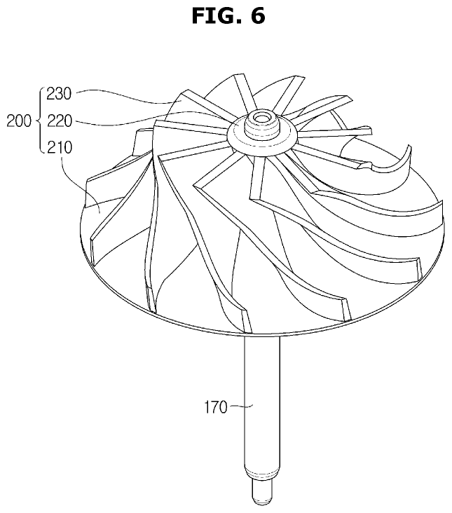

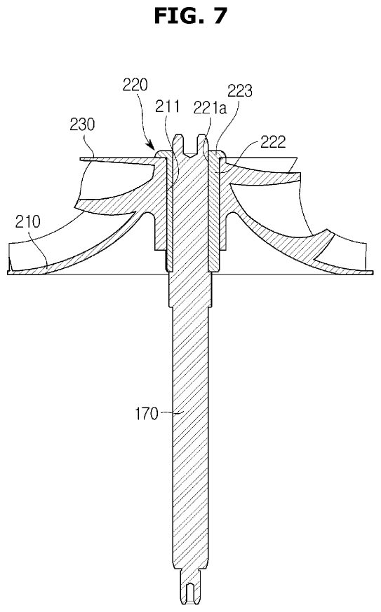

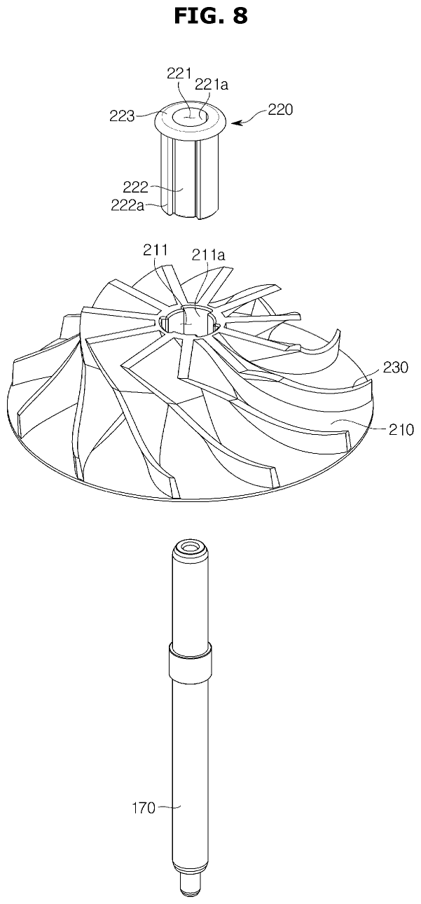

FIG. 6 is a perspective view illustrating a state in which an impeller and a rotor shaft are coupled in the motor assembly according to the present disclosure. FIG. 7 is a cross-sectional view illustrating a state in which the impeller and the rotor shaft are coupled in the motor assembly according to the present disclosure. FIG. 8 is a perspective view illustrating a state in which the impeller and the rotor shaft are separated in the motor assembly according to the present disclosure.

As illustrated in FIGS. 6 to 8, the impeller 200 may be configured to rotate together with the rotor shaft 170. The impeller 200 may include the hub 210 configured to guide air introduced through the inlet 121 and the shaft coupling member 220.

The impeller 200 may include the plurality of wings 230 configured to generate a suction force when the impeller 200 rotates. The shape and number of the plurality of wings 230 may be provided in various ways.

The hub 210 is configured to have a smaller cross-sectional area along the direction of the rotor shaft 170 to discharge air introduced in the direction of the rotor shaft 170 in the radial direction of the rotor shaft 170 as the impeller 200 rotates.

The plurality of wings 230 may be provided on the hub 210 to form an airflow by rotating together with the hub 210. The plurality of wings 230 may be provided on an outer surface of the hub 210.

The rotor 161 may be disposed on a rear surface of the hub 210, and the plurality of wings 230 may be disposed on a front surface of the hub 210 to form an airflow.

The hub 210 may include a hollow portion 211 configured to allow the shaft coupling member 220 to be coupled thereto.

The shaft coupling member 220 may be provided in the hollow portion 211 such that the hollow portion 211 may be prevented from being deformed when the rotor shaft 170 passes through the hollow portion 211.

In general, in order for the rotor shaft 170 to be press-fitted into the hollow portion 211, an outer circumferential surface of the rotor shaft 170 and an inner circumferential surface of the hollow portion 211 are formed to substantially coincide with each other, and thus when the rotor shaft 170 is press-fitted into the hollow portion 211, deformation may occur on the inner circumferential surface of the hollow portion 211.

In order to prevent such deformation, the impeller 200 may include the shaft coupling member 220. The shaft coupling member 220 may be coupled to the hollow portion 211 so that the rotor shaft 170 may be coupled to the hub 210.

A shaft insertion hole 221 may be formed in the shaft coupling member 220 to allow the rotor shaft 170 to be inserted therein. The shaft coupling member 220 may be disposed between the hub 210 and the rotor shaft 170.

The shaft insertion hole 221 may include a shaft coupling surface 221a corresponding to the outer circumferential surface of the rotor shaft 170. An inner diameter of the shaft insertion hole 221 formed through the shaft coupling surface 221a corresponds to an outer diameter of the rotor shaft 170 so that the rotor shaft 170 may be press-fitted into the shaft insertion hole 221.

However, the method in which the rotor shaft 170 is coupled to the shaft coupling member 220 is not limited thereto, and in the embodiment of the present disclosure, the rotor shaft 170 is press-fitted into the shaft insertion hole 221 so that the impeller 200 and the rotor shaft 170 may be integrally operated.

The coupling method of the impeller 200 and the rotor shaft 170 may include a method of applying a bond between the shaft insertion hole 221 and the rotor shaft 170. However, in the case of the impeller 200 that needs to rotate at a high speed, it may be difficult to firmly fix the impeller 200 and the rotor shaft 170 only by a coupling force of the bond.

Therefore, because it is difficult to maintain the concentricity of the rotor shaft 170 and the impeller 200, vibration may occur when the impeller 200 rotates.

As another coupling method of the impeller 200 and the rotor shaft 170, there may be a method in which the rotor shaft 170 having a spiral formed on the surface thereof passes through the shaft insertion hole 221, and then the rotor shaft 170 is supported by fastening a separate fixing member such as a nut (not shown) to the rotor shaft 170 passed through the shaft insertion hole 221.

However, a height of the entire motor assembly 100 may increase by a height of the nut (not shown), and thus the material cost for manufacturing the motor assembly 100 may increase.

In addition, a nut (not shown) located in the inlet 121 of the impeller 200 may hinder the flow of air sucked through the inlet 121, thereby reducing the performance of the cleaner 1, and when the impeller 200 rotates at a high speed, vibration or noise may occur in the vicinity of the nut (not shown).

The shaft coupling member 220 may include the shaft insertion hole 221 configured to allow the rotor shaft 170 to be inserted therein, and the diameter of the shaft insertion hole 221 may be smaller than the diameter of the rotor shaft 170 such that the rotor shaft 170 may be press-fitted into the shaft insertion hole 221.

That is, unlike the rotor shaft 170 is directly press-fitted into the hollow portion 211 of the hub 210, the rotor shaft 170 may be press-fitted into the shaft insertion hole 221 of the shaft coupling member 220, and then the shaft coupling member 220 may be coupled to the hollow portion 211 of the hub 210.

The rotor shaft 170 may be constituted of a metallic material. The impeller 200 may be constituted of a plastic material.

When the rotor shaft 170 is press-fitted into the shaft insertion hole 221, whether the impeller 200 is damaged may be determined according to an elongation at break of the impeller 200 constituted of a plastic material.

The impeller 200 may include the hub 210 constituted of a plastic material and including a hollow portion 211 provided such that the rotor shaft 170 may pass therethrough, and may include the shaft coupling member 220 positioned between the hollow portion 211 and the rotor shaft 170 and constituted of a plastic material different from the hub 210

The plastic material constituting the shaft coupling member 220 may have a higher elongation at break than the plastic material constituted of the hub 210. For example, the shaft coupling member 220 may be constituted of polycarbonate (PC), and the hub 210 may be constituted of reinforced PPA.

The shaft coupling member 220 constituted of a plastic material having a high elongation at break may not be damaged when the rotor shaft 170 is press-fitted into the shaft insertion hole 221, and may be tightly coupled to the rotor shaft 170 after the rotor shaft 170 is press-fitted into the shaft insertion hole 221 to enable high speed rotation of the impeller 200.

In addition, the shaft coupling member 220 constituted of a plastic material having a high elongation at break may prevent generation of vibration or noise between the shaft coupling surface 221a and the rotor shaft 170.

The plastic material constituting the hub 210 may include a high strength plastic material including carbon fibers. The plastic material constituting the plurality of wings 230 may be the same as the plastic material constituting the hub 210.

That is, the plastic material constituting the plurality of wings 230 may include a high strength plastic material including carbon fibers. The high strength plastic material including carbon fibers may include, for example, reinforced PEEK, reinforced PPS, reinforced PPA, reinforced PA, and the like.

The impeller 200 may not be damaged even at a high speed rotation of the impeller 200 because the hub 210 and the plurality of wings 230 except for the shaft coupling member 220 constituted of a plastic material having a high elongation at break may be constituted of a high strength plastic material.

A static friction coefficient with a metal of the impeller 200 constituted of a plastic material may affect the rotation between the rotor shaft 170 constituted of the metallic material and the impeller 200 constituted of the plastic material.

The plastic material constituting the shaft coupling member 220 may have a higher static friction coefficient with the metallic material than the plastic material constituting the hub 210.

The shaft coupling member 220 constituted of a plastic material having a high static friction coefficient with the metal may prevent revolving between the rotor shaft 170, which is press-fitted into the shaft insertion hole 221 with a high frictional force, and the impeller 200.

The static friction coefficient of the shaft coupling member 220 may be 0.2 or more. However, the present disclosure is not limited thereto.

The plastic material constituting the shaft coupling member 220 may include a soft material having a lower tensile strength than the plastic material constituting the hub 210. For example, the shaft coupling member 220 may be constituted of PPA, and the hub 210 may be constituted of reinforced PPA.

When the rotor shaft 170 is press-fitted into the shaft insertion hole 221, the shaft coupling member 220 constituted of a material having a low tensile strength may not transmit a stress higher than the tensile strength of the shaft coupling member 220 to the hub 210 and the like other than the shaft coupling member 220.

That is, due to the tolerance between the shaft insertion hole 221 and the rotor shaft 170, even if a stress greater than the tensile strength occurs in the shaft insertion hole 221 when the rotor shaft 170 is press-fitted into the shaft insertion hole 221, only the shaft coupling member 220 may be damaged.

Therefore, because the impeller 200 may be reused only by replacing the shaft coupling member 220, the material cost may be reduced.

The shaft coupling member 220 may include the shaft coupling surface 221a in contact with the rotor shaft 170 press-fitted into the shaft insertion hole 221, and the shaft coupling surface 221a may be constituted of a plastic material different from the hub 210.

That is, the shaft coupling member 220 is not entirely constituted of a plastic material different from the hub 210, but only the shaft coupling surface 221a in direct contact with the rotor shaft 170 is constituted of a plastic material different from the hub 210. However, the present disclosure is not limited thereto.

The shaft coupling member 220 may include a body portion 222 accommodated in the hollow portion 211 and a head portion 223 extending in the radial direction of the rotor shaft 170 from an upper side of the body portion 222.

When the impeller 200 rotates at a high speed, a low pressure may be formed in the inlet 121 so that a phenomenon in which the impeller 200 tries to be separated from the rotor shaft 170 in the direction toward the inlet 121 may occur.

Therefore, a diameter of the head portion 223 may be larger than that of the hollow portion 211 to prevent the hub 210 from being separated from the rotor shaft 170.

The shaft coupling member 220 may be coupled to the hollow portion 211 by a forced fit. However, the present disclosure is not limited thereto, and a coupling method of the shaft coupling member 220 and the hollow portion 211 may be provided in various ways.

For example, the shaft coupling member 220 may be insert injection molded integrally with the hollow portion 211, and the shaft coupling member 220 may be double injection molded with the hollow portion 211. That is, the shaft coupling member 220 may be integrally formed with the hub 210 by insert injection molding with the hub 210 along the inner circumferential surface of the hollow portion 211.

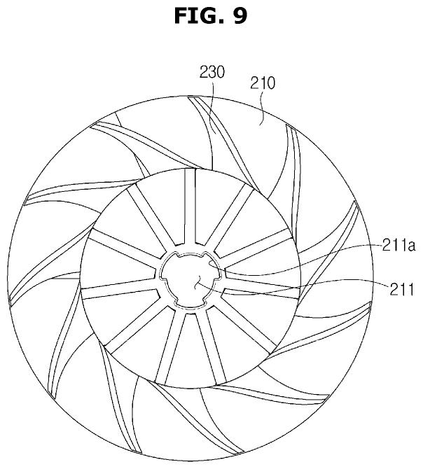

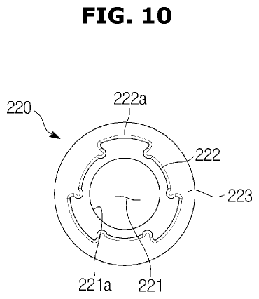

FIG. 9 is a cross-sectional view of the impeller excluding a shaft coupling member, which is viewed from the top to the bottom, in the motor assembly according to the present disclosure. FIG. 10 is a cross-sectional view of the shaft coupling member, which is viewed from the bottom to the top, in the motor assembly according to the present disclosure.

As illustrated in FIGS. 9 and 10, the shaft coupling member 220 may include a first coupling portion 222a provided in the body portion 222 to prevent revolving of the body portion 222 inserted into the hollow portion 211.

The hollow portion 211 may include a second coupling portion 211a configured to be coupled to the first coupling portion 222a in a locking manner.

The first coupling portion 222a may include a protrusion protruding in the radial direction of the rotor shaft 170 from the body portion 222, and the second coupling portion 211a may include a groove formed to allow the first coupling portion 222a to be inserted into the second coupling portion 211a.

The second coupling portions 211a may be formed in a groove shape along the direction of the rotor shaft 170 on an outer circumferential surface of the first coupling portion 222a and may be provided to be spaced apart from each other by a predetermined interval along a circumferential direction.

An edge of the second coupling portion 211a may be positioned farther in the radial direction of the rotor shaft 170 than an edge of the hollow portion 211 at the center of the hollow portion 211.

An edge of the body portion 222 may be positioned farther in the radial direction of the rotor shaft 170 than an edge of the shaft insertion hole 221 at the center of the shaft insertion hole 221.

An edge of the first coupling portion 222a may be positioned farther in the radial direction of the rotor shaft 170 than an edge of the body portion 222 at the center of the shaft insertion hole 221.

An edge of the head portion 223 may be positioned farther in the radial direction of the rotor shaft 170 than the edge of the first coupling portion 222a at the center of the shaft insertion hole 221. However, the present disclosure is not limited thereto.

Although the above embodiment illustrates that three of the first coupling portions 222a and three of the second coupling portions 211a are configured, the present disclosure is not limited thereto.

The first coupling portion 222a and the second coupling portion 211a may be provided in various shapes and numbers within a range to prevent the revolving of the body portion 222 inserted into the hollow portion 211.

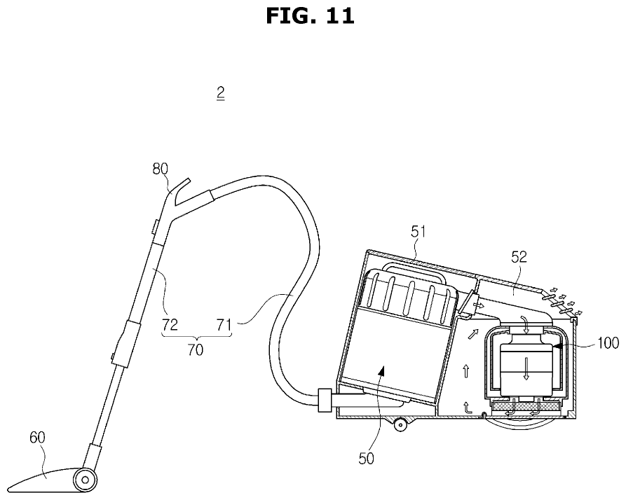

FIG. 11 illustrates a canister type cleaner including the motor assembly according to the present disclosure. Hereinafter, a canister type cleaner 2 including the motor assembly 100 will be described. Descriptions of components overlapping with those of the stick type cleaner 1 may be omitted.

The canister type cleaner 2 and the stick type cleaner 1 are classified only for convenience of description, and the motor assembly 100 according to the present disclosure may be applied to both the stick type cleaner 1 and the canister type cleaner 2.

The canister type cleaner 2 may include a cleaner body 50 and a suction head 60. A connection member 70 may be provided between the cleaner body 50 and the suction head 60 such that a suction force generated from the cleaner body 50 may be transmitted to the suction head 60.

The connection member 70 may include a connection hose 71 made of a rubber material and a connection pipe 72 connected to the connection hose 71. A handle 80 may be provided between the connection hose 71 and the connection pipe 72 such that the user may grip the handle by hand.

It is appropriate that the connection hose 71 is formed of a flexible corrugated pipe, one end thereof may be connected to the cleaner body 50, and the other end thereof may be connected to the handle 80.

The connection hose 71 may be configured to allow the suction device 60 to move freely within a predetermined radius about the cleaner body 50.

The connection pipe 72 is formed to have a predetermined length, one end thereof is connected to the suction head 60, and the other end thereof is connected to the handle 80, so that the user may grip the handle portion 80 and move the suction head 60 to clean the surface to be cleaned.

The connection hose 71 may be connected to the front of the cleaner body 50 to receive the sucked air.

The cleaner body 50 may include a driving device 52 in which the motor assembly 100 may be disposed therein and a dust collector 51. The motor assembly 100 may generate power in order to generate a suction force inside the cleaner body 50.

The dust collector 51 may be configured to filter out and collect dust or dirt in air introduced from the suction head 60.

While the present disclosure has been particularly described with reference to exemplary embodiments, it should be understood by those of skilled in the art that various changes in form and details may be made without departing from the spirit and scope of the present disclosure.

1. A motor assembly comprising:
a stator;
a rotor comprising a rotor shaft including a metallic material and configured to be rotatable by electromagnetic interaction with the stator;
a hub including a plastic material and comprising a hollow portion configured to allow the rotor shaft to pass therethrough; and
a shaft coupling member positioned between the hollow portion and the rotor shaft and including a plastic material different from a plastic material forming the hub.

2. The motor assembly according to claim 1, wherein
the plastic material forming the shaft coupling member has a higher elongation at break than the plastic material forming the hub.

3. The motor assembly according to claim 1, wherein
the plastic material forming the shaft coupling member has a higher static friction coefficient with the metallic material than the plastic material forming the hub.

4. The motor assembly according to claim 1, wherein
the plastic material forming the shaft coupling member comprises a ductile material having a lower tensile strength than the plastic material forming the hub.

5. The motor assembly according to claim 1, wherein
the shaft coupling member comprises:
a body portion accommodated in the hollow portion; and
a head portion extending in a radial direction of the rotor shaft from an upper side of the body portion.

6. The motor assembly according to claim 5, wherein
a diameter of the head portion is larger than a diameter of the hollow portion to prevent the hub from being separated from the rotor shaft.

7. The motor assembly according to claim 1, wherein
the shaft coupling member comprises a shaft insertion hole into which the rotor shaft is inserted, and
a diameter of the shaft insertion hole is smaller than a diameter of the rotor shaft such that the rotor shaft is press-fitted into the shaft insertion hole.

8. The motor assembly according to claim 7, wherein
the shaft coupling member comprises a shaft coupling surface in contact with the rotor shaft press-fitted into the shaft insertion hole, and
the shaft coupling surface includes a plastic material different from the plastic material forming the hub.

9. The motor assembly according to claim 1, wherein
the shaft coupling member is coupled to the hollow portion in a forced fitting manner.

10. The motor assembly according to claim 1, wherein
the shaft coupling member is insert injection molded integrally with the hollow portion.

11. The motor assembly according to claim 1, wherein
the shaft coupling member is double injection molded with the hollow portion.

12. The motor assembly according to claim 5, wherein
the shaft coupling member further comprises a first coupling portion provided in the body portion to prevent revolving of the body portion inserted into the hollow portion.

13. The motor assembly according to claim 12, wherein
the hollow portion includes a second coupling portion configured to be coupled to the first coupling portion in a locking manner.

14. The motor assembly according to claim 13, wherein
the first coupling portion comprises a protrusion protruding in the radial direction of the rotor shaft from the body portion, and
the second coupling portion comprises a groove to allow the first coupling portion to be inserted into the second coupling portion.

15. A cleaner comprising:
a cleaner body;
a suction head configured to suck foreign substances on a surface to be cleaned into the cleaner body; and
a motor assembly disposed inside the cleaner body,
wherein the motor assembly comprises:
a motor comprising a rotor shaft and rotatably configured; and
an impeller coupled to the rotor shaft to be rotatable together with the motor, and
wherein the impeller comprises:
a hub constituted of a high strength plastic material to prevent damage due to high speed rotation of the impeller; and
a shaft coupling member coupled to a hollow portion formed in the hub and including a plastic material different from a plastic material forming the hub.
